(19) United States
(12) Patent Application Publication
(10) Pub. No.: US 2002/0195993 A1
(43) Pub. Date: Dec. 26, 2002

(54) Structure of an AC adaptor for mobile telephones

(76) Inventor: Chiu Kai Chiu, Taipet City (TW)

Correspondence Address: Chiu Kai Chiu, PO Box 82-144, TAIPEI, TW

(21) Appl. No.: 09/886,090

(22) Filed: Jun. 22, 2001

(51) Int. Cl. H02J 7/00

(52) U.S. Cl. 320/114

(57) ABSTRACT

An AC adaptor for a mobile phone includes a converter, a USB connector connected with an end of the converter via a electrical cord, a plurality of power connectors connected with the converter via a plurality of electrical cords, whereby when in use, the USB connector is simply plugged into a USB socket of a personal computer while the power connectors can be connected to various kinds of mobile phones, so that voltage applied to the USB connector will charge the mobile phone.

### BACKGROUND OF THE INVENTION

(a) Technical Field of the Invention

This invention is related to an improvement in the structure of an AC (alternating current) adaptor for mobile telephones.

(b) Description of the Prior Art

With the prosperity in economy, the income per capita is continuously increasing, thereby enabling mobile phones to be affordable to almost every one and therefore resulting in the fact, that almost every one has got a mobile phone. However, after having been used for a certain period of time, the mobile phone has to be recharged by means of an AC adaptor. As shown in FIG. 1, the conventional AC adaptor for mobile phones generally comprises a charging seat 11 and a transformer 13, which is connected to the charging seat 11 via an electrical cord 12. The transformer of certain AC adaptors is fitted within the charging seat. When in use, the transformer 13 is plugged into an AC outlet and converts AC into DC for charging a mobile phone 2. Nevertheless, the conventional AC adaptor for mobile phones suffers from the following drawbacks:

1. It is bulky in volume, heavy, inconvenient to operate, and difficult to carry;

2. When no free AC outlet is available, the AC adaptor for mobile phones will become useless.

3. As a transformer, a voltage regulating circuit and a rectifying circuit are required for operation of the conventional AC adaptor, therefore the cost is increased and it can easily break down, and it cannot be used for a long period of time.

Therefore, it is an object of the present invention to provide an improved AC adaptor for mobile phones, which can obviate and mitigate the above-mentioned drawbacks.

### SUMMARY OF THE INVENTION

This invention is related to an improvement in the structure of an AC adaptor for mobile phones.

It is the primary object of the present invention to provide an improvement in the structure of an AC adaptor for mobile phones which includes a converter, a USB connector connected with an end of the converter via a electrical cord, a plurality of power connectors connected with the converter via a plurality of electrical cords, whereby when in use, the USB connector is simply plugged into a USB socket of a personal computer while the power connectors can be connected to various kinds of mobile phones, so that voltage applied to the USB connector will charge the mobile phone.

It is an object of the present invention to provide an improvement in the structure of an AC adaptor for mobile phones, which does not require a transformer for operation thereby reducing the volume, weight and even the cost.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a prior art AC adaptor for mobile phones;

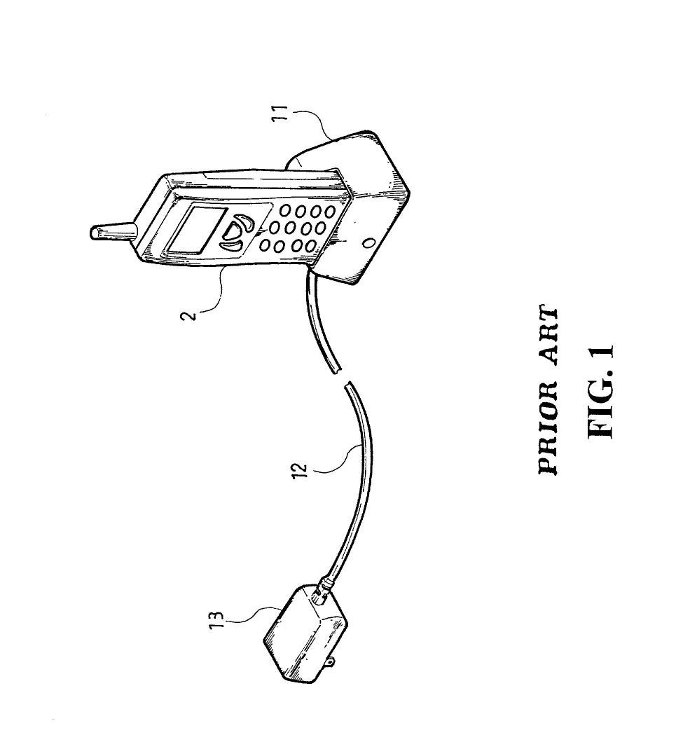

FIG. 2 is a perspective view of an AC adaptor for mobile phones according to the present invention;

FIG. 3 is a perspective view of a second preferred embodiment according to the present invention; and

FIG. 4 is a working view of the present invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

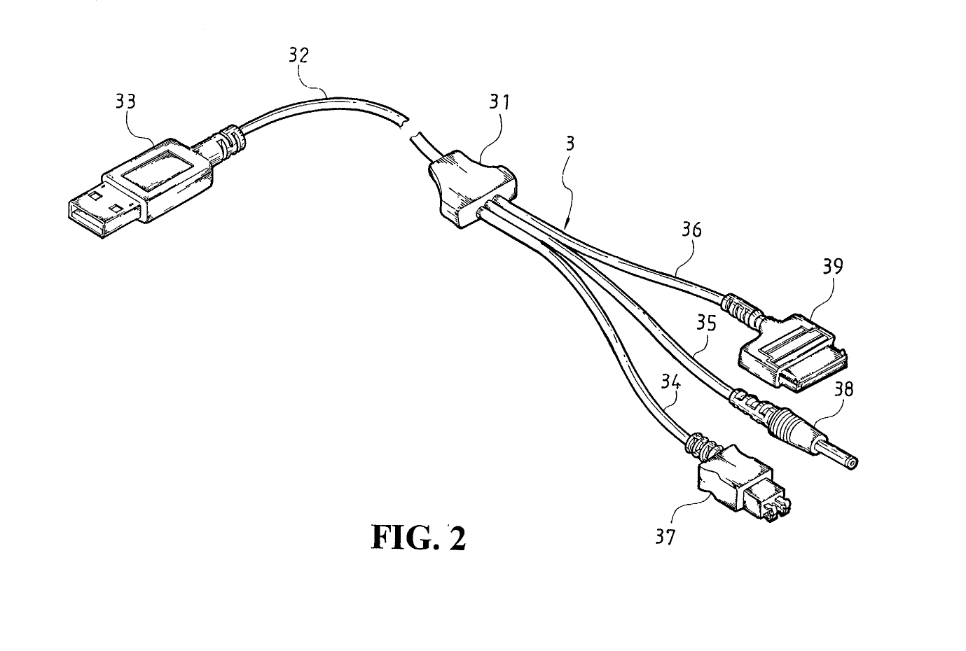

With reference to the drawings and in particular to FIGS. 2 thereof, the AC (alternating current) adaptor 3 for mobile phones according to the present invention comprises a converter 31, a USB (universal serial bus) connector 33 connected with an end of the converter 31 via an electrical cord 32, a first power connector 37 connected to the other end of the converter 31 via an electrical cord 34, a second power connector 38 connected to the other end of the converter 31 via an electrical cord 35, and a third power connector 39 connected to the other end of the converter 31 via an electrical cord 36. When in use, the USB connector 33 is simply plugged into a USB socket of a personal computer while the power connectors 37, 38 and 39 can be connected to various kinds of mobile phones.

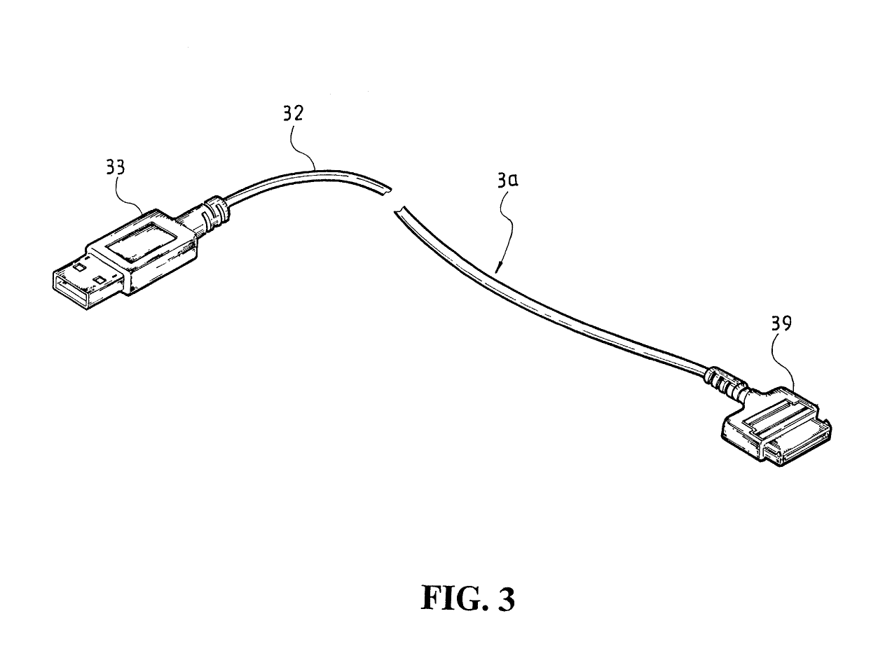

Referring to FIG. 3, the USB connector 33 is directly connected to a power connector 39 via an electrical cord 3a, so that it can be used for particular types of mobile phones.

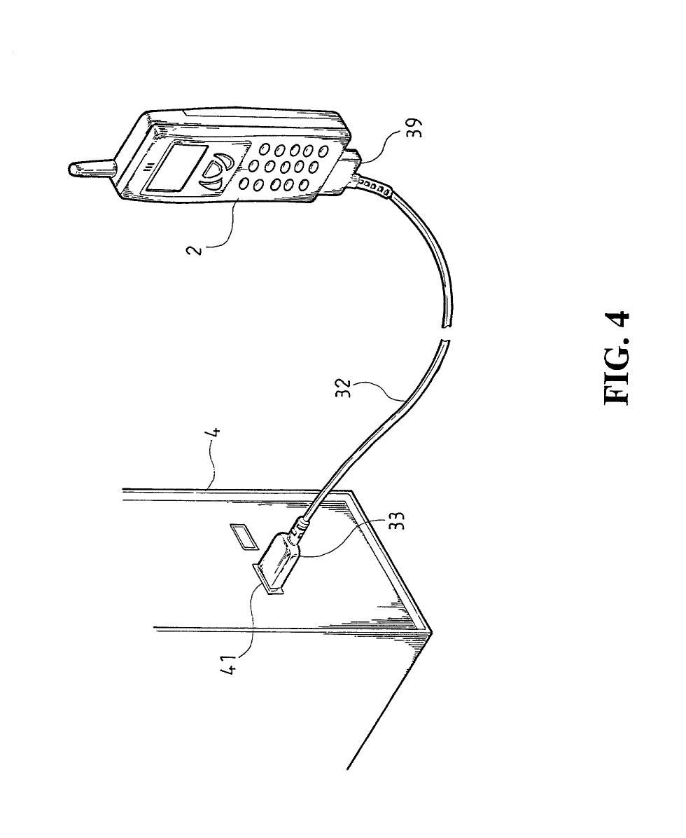

Looking now at FIG. 4, when in use, the USB connector 33 is plugged into a USB socket 41 of a personal computer 4 while the power connector 39 is connected to a connector mounted at the bottom of a mobile phone 2, so that the voltage applied to the USB socket 41 (commonly used USB sockets are designed for engaging memory cards and generally have positive and negative voltages) will charge the batteries (not shown) in the mobile phone 2. Furthermore, as the USB socket 41 can provide a steady voltage, it is unnecessary to mount an additional voltage regulating device.

Accordingly, the present invention has the following advantages:

1. No transformer is required, thereby reducing the weight and size of the AC adaptor and making it easier to stow and carry.

2. It enables a mobile phone to be conveniently charged by connecting with a USB socket of a personal computer.

3. As no transformer is required, the cost of the AC adaptor can be reduced and the breakdown rate is lowered, thereby increasing its service life.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An AC adaptor for a mobile phone comprising:
a converter;
a USB connector connected with an end of said converter via an electrical cord;
a plurality of power connectors connected with said converter via a plurality of electrical cords;
whereby when in use, said USB connector is simply plugged into a USB socket of a personal computer while said power connectors can be connected to various kinds of mobile phones, so that voltage applied to the said USB connector will charge said mobile phone.
